(19) United States
(12) Patent Application Publication
(10) Pub. No.: US 2015/0138940 A1
(43) Pub. Date: May 21, 2015

(54) PLAYBACK APPARATUS AND DISK INFORMATION DISPLAY METHOD

(71) Applicant: Kazuya Hamakami, Tokyo (JP)

(72) Inventor: Kazuya Hamakami, Tokyo (JP)

(73) Assignee: MITSUBISHI ELECTRIC CORPORATION, Tokyo (JP)

(21) Appl. No.: 14/402,062

(22) PCT Filed: Aug. 3, 2012
(86) PCT No.: PCT/JP2012/069873

§ 371 Date: Nov. 18, 2014

(51) Int. Cl. G11B 7/005

(52) U.S. Cl. CPC G11B 7/005
USPC 369/47.11

(57) ABSTRACT

When a playback unit 1 is playing back a pause area, a display controller 4 associates the track number of the track played back just before the pause area with the pause area, and causes a display device 40 to display them; and counts the playback elapsed time of the pause area up to the total playback time successively from the playback elapsed time at the end of the playback of the immediately preceding track, and causes the display device 40 to display the counted value as the playback elapsed time.

### TECHNICAL FIELD

The present invention relates to a playback apparatus and a disk information display method, which display a playback state of a storage medium such as an optical disk having a pause area between tracks.

### BACKGROUND ART

Generally, the recording surface of an optical disk has regions consisting of a PCA (Power Calibration Area), a PMA (Program Memory Area), a lead-in area (Lead-In Area), tracks, and a lead-out area (Lead-Out Area) formed from the innermost circumference toward the outermost circumference. Music information or the like is recorded on a track or sometimes on tracks. In this case, an area called a pause area can be provided between tracks, and the pause area serves as an interval section until the playback start of the next track. Even if the pause area is provided between the tracks, the start time of the track recorded as TOC (Table of Contents) information of the PMA area and lead-in area indicates the start time of the track next to the pause area. On the other hand, the TOC information does not store the end time of each track. In addition, the end position of a track continues to the head position of the pause area provided before the next track.

FIG. 5(a) is a diagram showing a configuration of the tracks and pause areas, in which the area of a track number “03” consists of a pause area P3 and a track T3, and the area of a track number “04” consists of a pause area P4 and a track T4.

The start time of the start position t3 of the track T3 and that of the start position t4 of the track T4 can be acquired from the TOC information. As shown in FIG. 5(b), the start time is given by the corresponding track number and the track start time represented in terms of “MIN”, “SEC”, and “FRAME”. The track start time indicates the position from the top of the disk.

On the other hand, the TOC information does not record the end time of the track T3 or T4. In addition, the end position of the track T3 continues to the head position of the pause area P4 of the next track T4. Accordingly, the total playback time of each track is given by the sum of the playback duration of the track and the playback duration of the successive pause area of the track. A concrete example will be described with reference to FIG. 5(a). The total playback time of the Track3 is given by subtracting the start time of the start position t3 of the track T3 from the start time of the start position t4 of the track T4. Accordingly, the total playback time of the Track3 includes the playback duration of the pause area P4 of the successive Track4.

Next, FIG. 6 shows a display example of the playback duration of an optical disk having a pause area. As shown in FIG. 6(a), the playback elapsed time of the pause area is updated by counting down the numerical value of the minus notation. On the other hand, the playback elapsed time of the track is updated by counting up the numerical value. In addition, as shown in FIG. 6(b) and FIG. 6(c), although the playback elapsed time/total playback time is given by “2:55/3:00” at the playback end position of the track T3, when the playback moves to the pause area P4, although it is within the total playback time of the Track3, the track number advances to “04” and the count down of the pause area T4 is started. Accordingly, as far as the display is concerned, before being counted up to the total playback time “3:00” of the Track3, the playback elapsed time shifts to the counting of the Track4, and the playback elapsed time of the pause area is given by the minus notation. The display, however, can offer a problem of causing a user to feel that something is wrong or to misunderstand that the optical disk has a failure.

Patent Document 1 discloses a method of acquiring the current playback time and the remaining playback duration of each track. In this method, when the playback data is composed of a plurality of types of packs (the smallest unit in the data transfer processing) in a DVD video capable of playing back digital audio, and when time cannot be obtained by using the packs because the bit transfer rates of the plurality of types of packs differ from each other, the method acquires from the digital audio data the start time data of the track, the playback timing data of the pack of the current playback, and the playback duration data about the track, and obtains the current playback time and the remaining playback duration from the data acquired according to a prescribed formula.

### PRIOR ART DOCUMENT

Patent Document 1: Japanese Patent Laid-Open No. 2000-173248.

### DISCLOSURE OF THE INVENTION

### Problems to be Solved by the Invention

However, the technique disclosed in the foregoing Patent Document 1 does not suppose the playback of a storage medium having a pause area between tracks. Accordingly it offers a problem of being unable to improve, in the display of the playback elapsed time of the pause area, the fact that the display shifts to the next track before it reaches the total playback time, or the fact that the playback elapsed time of the pause area is displayed in the minus notation; and presents a problem of being unable to solve the fault that the display can cause a user to feel that something is wrong or to lead to a misunderstanding.

The present invention is implemented to solve the foregoing problems. Therefore it is an object of the present invention to provide a display capable of preventing a user from feeling that something is wrong or from leading to a misunderstanding as to the display of the playback position information during playback of a pause area.

### Means for Solving the Problems

According to a playback apparatus in accordance with the present invention, when a playback unit plays back a pause area, a display controller causes a display unit to display the track number of a track which is played back just before the pause area by associating the track number with the pause area, counts the playback elapsed time of the pause area successively from the playback elapsed time at the end of the immediately preceding track up to the total playback time, and causes the display unit to display the playback elapsed time of the pause area.

### Advantages of the Invention

According to the present invention, it can prevent a user from feeling that something is wrong or from leading to a misunderstanding as to the display of the playback position information during the playback of the pause area.

### BRIEF DESCRIPTION OF THE DRAWINGS

FIG. 1 is a block diagram shown a configuration of a playback apparatus of an embodiment 1;

FIG. 2 is a flowchart showing the operation of the playback apparatus of the embodiment 1;

FIG. 3 is a diagram showing a display example of the playback apparatus of the embodiment 1;

FIG. 4 is a diagram showing a display example of the playback apparatus of the embodiment 1;

FIG. 5 is a diagram showing a configuration of tracks and pause areas; and

FIG. 6 is a diagram showing a display example of playback position information based on TOC information.

### BEST MODE FOR CARRYING OUT THE INVENTION

The best mode for carrying out the invention will now be described with reference to the accompanying drawings to explain the present invention in more detail.

### Embodiment 1

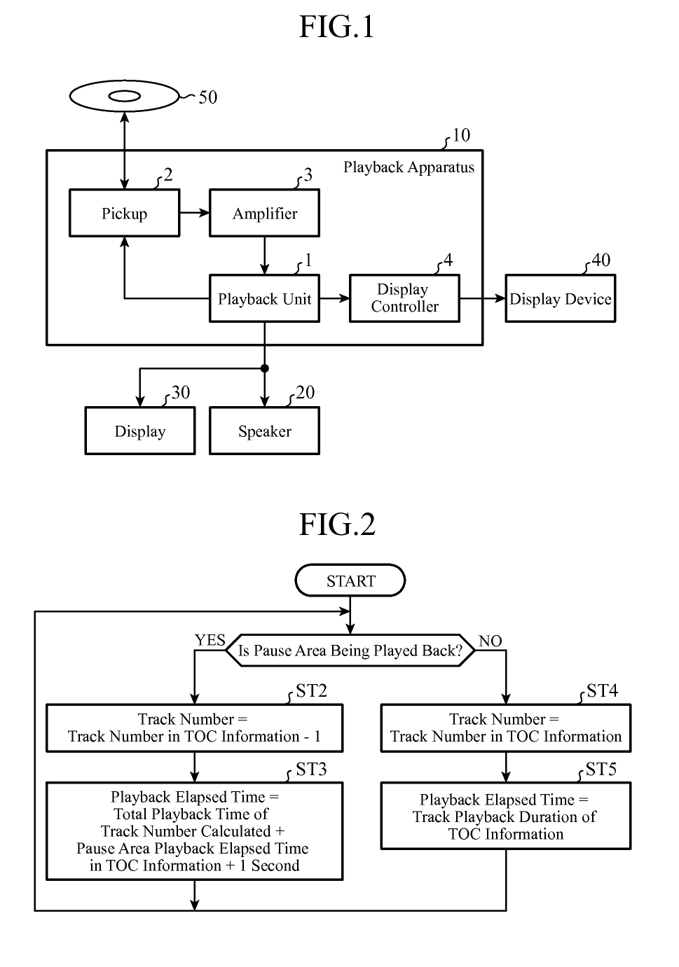

FIG. 1 is a block diagram shown a configuration of a playback apparatus of an embodiment 1 in accordance with the present invention.

The playback apparatus 10 comprises a playback unit 1, a pickup 2, an amplifier 3, and a display controller 4. In addition, the playback apparatus 10 is connected to a speaker 20 and a display 30 that output played-back music information and video information, respectively, and to a display device (display unit) 40 that shows a playback state of the music information and video information the playback apparatus 10 plays back. The following description will be made with reference to FIG. 1 and using an example in which an optical disk (storage medium) 50 is a CD that stores music information. Incidentally, as for the display 30 and the display device 40, they can be comprised of the same display means.

To play back the optical disk 50, the playback unit 1 drives the pickup 2 and reads the music information recorded on the optical disk 50. The music information read from the optical disk 50 is amplified by the amplifier 3, followed by decoding through the playback unit 1 and outputting as a music signal, thereby being output as music (sound) from the speaker 20.

The optical disk 50 has TOC information stored in a program area. The TOC information provides the number of pieces of music information (the number of tracks), the start position of each track, and the track position and playback elapsed time of the current track when playing back the music information, and is supplied to the playback unit 1 when the music information is played back. In addition, the TOC information stores time information about a pause area when the pause area is provided between tracks.

The TOC information is supplied to the display controller 4 via the playback unit 1, and the display controller 4 acquires from the TOC information the music number information, the playback duration of the music associated with the music number information, and the playback elapsed time which is the time from the start of the playback of the music. Furthermore, the display controller 4 calculates, from the acquired information, the music number information and the current playback elapsed time with respect to the total playback time to be displayed on the display device 40, and controls the display device 40 to display them.

Although the display controller 4 performs the same display control as the conventional one while playing back each track, when playing back the pause area, it carries out characteristic processing of changing the track number and displaying it, and furthermore, of changing the count-down display of the playback elapsed time to the count-up display. The characteristic display processing will be described with reference to FIG. 2.

FIG. 2 is a flowchart showing the operation of the display controller of the playback apparatus of the embodiment 1.

The display controller 4 refers to the TOC information supplied from the playback unit 1, and decides on whether the playback apparatus is playing back the pause area or not from the total playback time and the current playback time of the current playback track (step ST1). When it is playing back the pause area (YES at step ST1), the display controller 4 sets as the current track number the value obtained by subtracting “1” from the track number acquired from the track number information in the TOC information (step ST2). Furthermore, it acquires the total playback time of the track number calculated from the TOC information at step ST2, and the playback elapsed time of the current pause area, adds the playback elapsed time of the pause area to the total playback time acquired, and further adds “1 second” to yield the current playback elapsed time (step ST3).

On the other hand, when the playback apparatus is not playing back the pause area (NO at step ST1), the display controller 4 assigns the track number in the TOC information to the current track number (step ST4), and the playback elapsed time acquired from the TOC information to the current playback elapsed time (step ST5).

After the processing at step ST3 or step ST5, the flow is returned to the decision processing at step ST1.

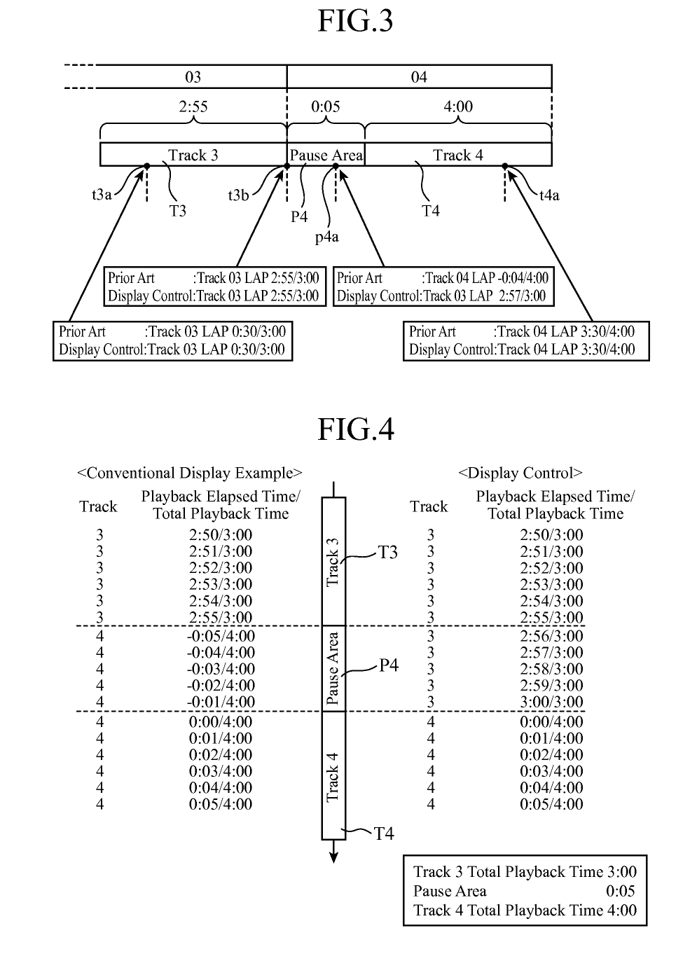

FIG. 3 shows an example of the track number and the playback elapsed time/total playback time displayed on the display device 40 during the playback of the pause area when executing the processing at step ST2 and step ST3 shown in FIG. 2.

FIG. 3 shows a track T3, track T4 and a pause area P4 at the top of the track T4. In addition, in the display of the playback elapsed time at each point, the upper line shows a conventional display example and the lower line shows a display example passing through the display controller 4. As for the playback positions t3a and tab of the track T3 and the playback position t4a of the track T4, since the display controller 4 decides that they are not the playback of the pause area, it executes the display processing at step ST4 and step ST5 to display the information acquired from the TOC information as the playback position information. Accordingly, the display example passing through the display controller 4 does not have any difference from the conventional display example.

On the other hand, at the playback position p4a of the pause area, the display controller 4 acquires the track number “4” and playback elapsed time “−0:04” from the TOC information. Accordingly, the display controller 4 obtains the track number “3” by subtracting “1” from the track number “4” at step ST2, and calculates the current playback elapsed time “2:57” by acquiring the total playback time “3:00” of the track number “3” from the TOC information at step ST3, by adding the playback elapsed time “−0:04” to the total playback time “3:00” acquired, and by further adding “0:01”. Thus, although the conventional example displays “Track 04 LAP −0:04/4:00”, the current embodiment displays “Track 03 LAP 2:57/3:00” in response to the display control of the display controller 4.

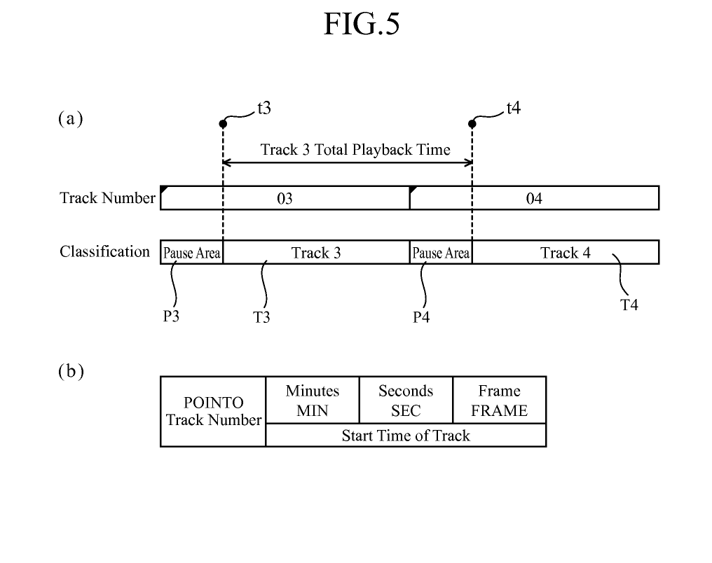

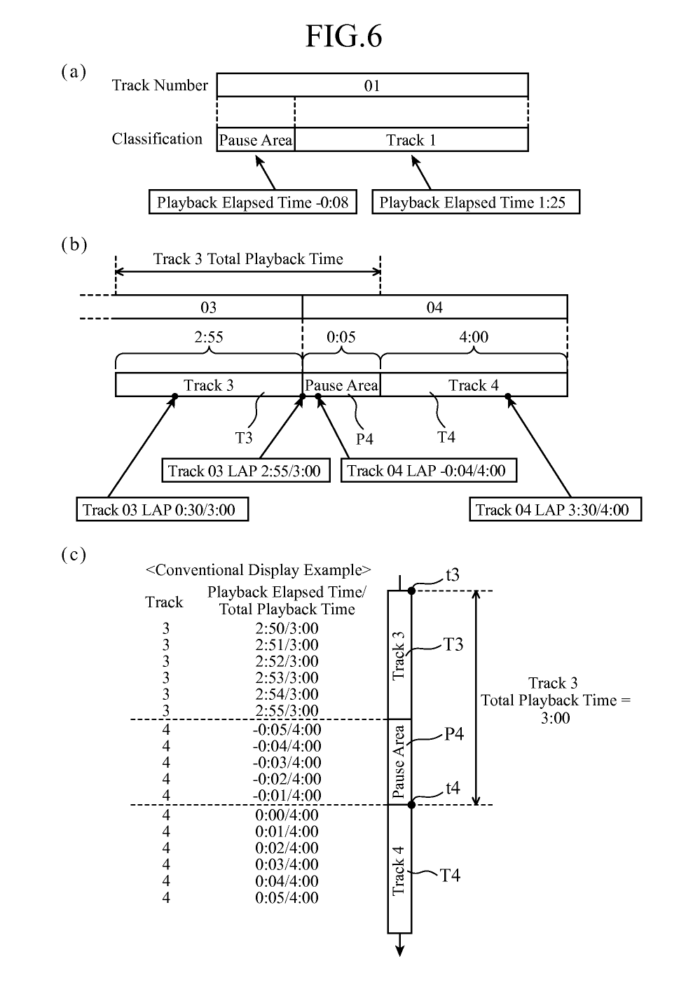

FIG. 4 shows details of the conventional display example and the display example passing through the display controller 4.

In the pause area P4 after the playback elapsed time/total playback time “2:55/3:00” of the track number “3”, the conventional display example shifts to the track number “4”, counts down the playback elapsed time in the minus notation, and displays as the total playback time the total playback time of the track number “4”.

On the other hand, as for the display based on the display control of the display controller 4, in the pause area P4 after the playback elapsed time/total playback time “2:55/3:00” of the track number “3”, the display controller 4 counts up the playback elapsed time up to “3:00” while maintaining the track number “3”, shifts to the track number “4” after that, and then counts up the total playback time as to the track number “4”.

In this way, in the pause area P4, the current embodiment carries out the display control at step ST2 and step ST3 described above. Thus, in the example of FIG. 3 and FIG. 4, it considers the pause area P4 at the top of the Track4 as the area of the Track3, thereby being able to carry out the count-up display as to the total playback time of the Track3. Accordingly, it counts up to the total playback time of the Track3, and can output the count-up display of the playback elapsed time of the pause area.

As described above, according to the embodiment 1, it is configured in such a manner as to comprise the display controller 4 that when making a decision that the pause area is being played back now, subtracts “1” from the track number indicated by the TOC information and displays it, displays the total playback time of the track number after the subtraction, and further adds to the total playback time the playback elapsed time of the pause area acquirable from the TOC information and “1 second” to count up and display the playback elapsed time of the pause area being played back. This makes it possible to count up to the total playback time of each track even when the pause area is provided. Furthermore, it can count up and display the playback elapsed time of the pause area. Thus, it can prevent the counting from shifting to the next track number before reaching the total playback time, and the playback elapsed time of the pause area from being represented in the minus notation, thereby being able to prevent a user from feeling that something is wrong or from misunderstanding that the optical disk has a fault.

Incidentally, it is to be understood that variations of any components of the individual embodiments or removal of any components of the individual embodiments is possible within the scope of the present invention.

### INDUSTRIAL APPLICABILITY

As described above, a playback apparatus in accordance with the present invention is applicable to an audio playback apparatus and the like capable of implementing the display without providing a user with a feeling that something is wrong.

### DESCRIPTION OF REFERENCE SYMBOLS

1 playback unit; 2 pickup; 3 amplifier; 4 display controller; 10 playback apparatus; 20 speaker; 30 display; 40 display device; 50 optical disk.

What is claimed is:

1. A playback apparatus comprising:
a playback unit that carries out playback of a storage medium including a pause area which is placed between tracks and serves as an interval section until playback of a next track starts; and
a display controller that acquires, by referring to a program area of the storage medium, a track number indicating a track and a pause area just before the track, a total playback time which is a sum total of playback duration of the track and playback duration of the pause area just after the track, and individual playback elapsed times the playback unit takes to play back the track and the pause area, and that causes a display unit to display information indicating a playback state of the storage medium by the playback unit, wherein
the display controller, when the playback unit plays back the pause area, causes the display unit to display the track number of the track which is played back just before the pause area by associating the track number with the pause area, counts the playback elapsed time of the pause area successively from the playback elapsed time at the end of the immediately preceding track up to the total playback time, and causes the display unit to display the counted value as the playback elapsed time.

2. A disk information display method that plays back an optical disk including a pause area which is placed between tracks and serves as an interval section until playback of a next track starts; that acquires, by referring to a program area of the optical disk, a track number indicating a track and a pause area just before the track, a total playback time which is a sum total of playback duration of the track and playback duration of the pause area just after the track, and individual playback elapsed times taken to play back the track and the pause area which are being played back, and that displays information indicating a playback state of the optical disk, wherein
a display controller comprises:
a step of displaying, when playing back the pause area, the track number of the track which is played back just before the pause area by associating the track number with the pause area; and
a step of counting the playback elapsed time of the pause area successively from the playback elapsed time at the end of the immediately preceding track up to the total playback time, and of displaying the counted value as the playback elapsed time.
